(19) United States
(12) Patent Application Publication
(10) Pub. No.: US 2015/0034469 A1
(43) Pub. Date: Feb. 5, 2015

(54) FORMABLE INPUT KEYPAD AND DISPLAY DEVICE USING THE SAME

(71) Applicant: Samsung Display Co., Ltd., Yongin-City (KR)

(72) Inventor: Jiuzhi Xue, San Jose, CA (US)

(73) Assignee: Samsung Display Co., Ltd., Yongin-City (KR)

(21) Appl. No.: 14/178,207

(22) Filed: Feb. 11, 2014

Related U.S. Application Data
(60) Provisional application No. 61/862,481, filed on Aug. 5, 2013.

(51) Int. Cl. H01H 13/85; H01H 13/704

(52) U.S. Cl. CPC H01H 13/85; H01H 13/704
USPC 200/5 A

(57) ABSTRACT

A formable input keypad includes: an electroactive polymer (EAP) layer having a first surface and a second surface opposite the first surface; a first conductive electrode pattern defining outlines of user input keys at the first surface of the EAP layer; and a second conductive electrode pattern at the second surface of the EAP layer.

### CROSS-REFERENCE TO RELATED APPLICATION(S)

This patent application claims the priority to and the benefit of U.S. Provisional Application Ser. No. 61/862,481, filed Aug. 5, 2013, titled “Apparatus for Converting between a Transparent Flat Surface, and a Transparent Surface Having Protrusions Positioned to Feel Like a Keyboard,” the entire content of which is incorporated herein by reference.

### BACKGROUND

1. Field

Embodiments of the present invention relate to formable input keypads.

2. Related Art

Touch input display devices have become increasingly popular, and are widely used, such as in cell phones, computer monitors, televisions, tablets, etc. Touch input display devices allow a user to view a displayed image and to concurrently interact with the displayed image by inputting commands via, for example, the user's finger or a stylus.

Generally, touch input display devices have a flat and hard surface, and do not have physical input keys for a user to input commands. Because of the flat surface, touch input display devices do not typically allow a user to receive tactile feedback when touching the input keys (e.g., users are not able to physically feel a keyboard when typing on a virtual keyboard displayed on the touch input display device).

However, many users prefer the feel of physical keys or buttons when inputting commands, as opposed to the unresponsive sensation of a flat surface of a touch input display device. Physical input keys improve data entry and navigation accuracy, while also increasing typing speed.

### SUMMARY

Aspects of embodiments of the present invention are directed toward a formable input keypad and a display device using the same.

Embodiments of the present invention provide physical input keys that can be activated and de-activated by a user of a display device, thereby increasing comfort of use, accuracy of command inputs, and the speed with which a user may accurately input commands.

In an embodiment of the present invention, there is provided a formable input keypad including: an electroactive polymer (EAP) layer having a first surface and a second surface opposite the first surface; a first conductive electrode pattern defining outlines of user input keys at the first surface of the EAP layer; and a second conductive electrode pattern at the second surface of the EAP layer.

The EAP layer may be adapted to contract at locations of the first conductive electrode pattern when a voltage is applied thereto such that the user input keys protrude.

The second conductive electrode pattern at the second surface of the EAP layer may face away from the user and substantially cover the second surface of the EAP layer.

The first conductive electrode pattern may be coupled to ground.

The formable keypad may further include a protective coating covering the first conductive electrode pattern.

The second electrode pattern may be patterned to correspond to the outlines of the user input keys.

The first electrode pattern may be patterned on substantially an entirety of the first surface of the EAP layer.

The first electrode pattern may be divided into zones, each zone being configured to independently receive the voltage.

One or more of the respective ones of the zones may receive the voltage according to an orientation of the formable keypad.

The voltage may be about 1 kV.

Another embodiment of the present invention provides a display device including: a substrate; a display panel on the substrate; a formable input keypad on the display panel, the formable input keypad including: an electroactive polymer (EAP) layer having a first surface and a second surface opposite the first surface; a first conductive electrode pattern defining outlines of user input keys at the first surface of the EAP layer; and a second conductive electrode pattern at the second surface of the EAP layer.

The EAP layer may be adapted to contract at locations of the first conductive electrode pattern receiving a voltage such that the user input keys protrude.

The second conductive electrode pattern may face toward the display panel and substantially cover the second surface of the EAP layer.

The first conductive electrode pattern may be coupled to ground.

A protective coating may cover the first conductive electrode pattern.

The second electrode pattern may be patterned to form the outlines of the user input keys.

The first electrode pattern may be patterned on substantially an entirety of the first surface.

The first electrode pattern may be divided into zones, each zone being configured to independently receive the voltage.

The zones may be configured to receive the voltage based on an orientation of the formable keypad.

The voltage may be about 1 kV.

### BRIEF DESCRIPTION OF THE DRAWINGS

The accompanying drawings, together with the specification, illustrate exemplary embodiments of the present invention, and, together with the description, serve to explain the aspects of the present invention.

FIG. 1 is a top view illustration of a display device according to an embodiment of the present invention.

FIG. 2A is a cross-sectional view of the display device shown in FIG. 1 taken along the line II-II when there is no applied voltage or when the electroactive polymer is in a quiescent state.

FIG. 2B is a cross-sectional view of the display device shown in FIG. 1 taken along the line II-II when a voltage is applied or when the electroactive polymer is activated.

FIG. 2C is a cross-sectional view of a display device according to another embodiment of the present invention.

FIG. 2D is a cross-sectional view of a display device according to another embodiment of the present invention.

FIG. 3A is a top view illustration of a display device according to another embodiment of the present invention.

FIG. 3B is a top view illustration of the display device shown in FIG. 3A when used in a portrait orientation.

FIG. 3C is a top view illustration of the display device shown in FIG. 3A when used in a landscape orientation.

FIG. 4 is a cross-sectional illustration of a display device according to another embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Expressions such as “at least one of,” when preceding a list of elements, modify the entire list of elements and do not modify the individual elements of the list. Further, the use of “may” when describing embodiments of the present invention refers to “one or more embodiments of the present invention.”

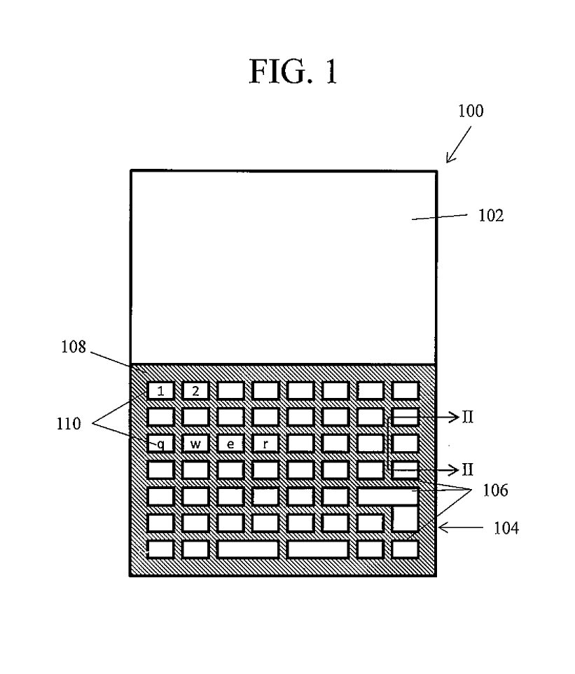

FIG. 1 is a top view illustration of a display device according to an embodiment of the present invention.

Referring to FIG. 1, a display device 100 includes a display area 102 and a formable keyboard area 104. In the keyboard area 104, the display device 100 includes a top conductive electrode (e.g., a first conductive electrode pattern) 108 and keys 106. The top conductive electrode 108 is patterned at the keyboard area 104 such that it surrounds the keys 106 of the keyboard area 104 and is configured to compress or contract a top surface (e.g., a first surface) of the display device 100 at portions or locations where the top conductive electrode 108 is located on the display device 100. The compression or contraction of the top surface occurs in a direction that is perpendicular to the plane of the top surface of the display device 100 (e.g., the thickness of the top surface layer of the display device 100 is compressed at locations where the top conductive electrode 108 is on the display device 100). This feature of embodiments of the present invention is described in more detail below.

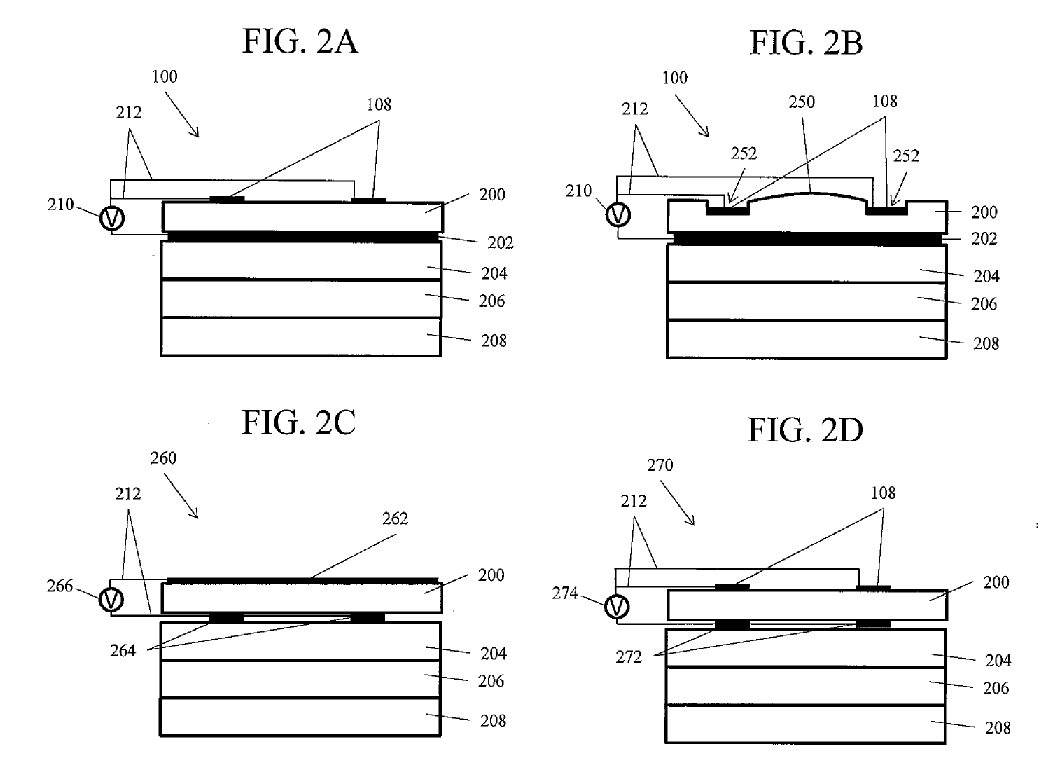

The compression of portions of the top conductive electrode 108 of the keyboard 104 may be in response to a voltage that is applied to the top conductive electrode 108 and a bottom conductive electrode (e.g., a second conductive electrode pattern) 202 (see FIG. 2A). In this case, the voltage may be applied to the keyboard 104, but might not be applied to the display area 102, which does not include the top conductive electrode 108.

By compressing the display device 100 at the portions of the top conductive electrode 108, a user is able to physically feel the keys 106, which protrude as a result of the surrounding portions of the top conductive electrode 108 of the keyboard 104 that are compressed.

The top conductive electrode 108 may be transparent so that images may be fully and clearly displayed to the user during normal operation of the display device 100 (e.g., when the keyboard 104 is not in use). Such embodiments of the present invention allow the full surface of the display device 100 to be utilized as a display area without distortion or interference of the images by the top conductive electrode 108. The top conductive electrode 108 may be made from indium tin oxide (ITO), silver nanowires, copper metal mesh, etc.

Additionally, the display device 100 may be programmed to display characters corresponding to the locations of each key 106 such that the displayed characters are presented towards the user. For example, if the keyboard 104 is patterned as a standard QWERTY keyboard, the display device 100 may display characters ‘q,’ ‘w,’ ‘e,’ and ‘r’ in a row such that these characters are displayed though the keys 106 towards the user, as illustrated by the displayed characters 110 shown in FIG. 1. Furthermore, the display device 100 may trigger tactility of the keyboard 104 during certain functions of the display device 100, such as when a user is typing a message. During use of the keyboard 104, the display area 102 may respond to what the user inputs into the keyboard 104 by displaying the user's inputs (e.g., displaying the letters that the user types).

Embodiments of the present invention are not limited to a QWERTY keyboard, as the display device 100 may display various character layouts through the keys 106. For example, the keys 106 may correspond to other alphanumeric keyboard configurations (e.g., Dvorak keyboard), to keyboards including foreign language characters, and/or other variants of keyboard layouts.

Additionally, the top conductive electrode 108 is not limited to being an outline of a keyboard, as the top conductive electrode 108 may delineate any desired input scheme, such as gaming device buttons, a number pad, or any other touch input configuration.

In embodiments of the present invention where the top conductive electrode 108 does not outline a keyboard, the display device 100 may display appropriate characters through the keys 106 corresponding to the input layout outlined by the top conductive electrode 108. In an embodiment of the present invention, the top conductive electrode 108 may be patterned to facilitate use of a calculator, and therefore the display device 100 may display numerical characters, mathematical operators, etc. In another embodiment of the present invention, the top conductive electrode 108 may be patterned to facilitate use of a gaming device controller, and therefore the display device 100 may display a directional pad, input buttons, etc.

FIG. 2A is a cross-sectional view of the display device shown in FIG. 1 taken along the line II-II when there is no applied voltage or when the electroactive polymer is in a quiescent state.

Referring to FIG. 2A, display device 100 includes the top conductive electrode 108, electroactive polymer (EAP) 200, bottom conductive electrode 202, touch panel 204, display panel 206, and substrate 208. Additionally, voltage source 210 is coupled to the top conductive electrode 108 and to the bottom conductive electrode 202 through wiring 212. FIG. 2A illustrates a state in which no voltage is applied to the conductive electrodes, and in which the EAP 200 maintains a substantially uniform or consistent thickness, causing the keyboard 104 to lack the physical tactile characteristics (e.g., the key 106 of the keyboard 104 remains flat, or unraised).

The EAP 200 may be transparent so that images generated from the display panel 208 at regions underneath the EAP 200 are easily seen by the user. The EAP 200 may contract or compress when a voltage is applied at the top conductive electrode 108 or at the bottom conductive electrode 202. The base material of the EAP 200 may be a flexible and transparent material such as silicone (PDMS).

The bottom conductive electrode 202 may also be transparent so that images generated from the display panel 208 in regions underneath the bottom conductive electrode 202 are fully displayed to the user during normal operation of the display device 100 (e.g., when the EAP 200 is in a flat state) such that the full surface of the display device 100, including both the display area 102 and the area corresponding to the keyboard 104, may display images to the user with substantially no distortion or interference caused by the bottom conductive electrode 202. The bottom conductive electrode 202 may be made from indium tin oxide (ITO), silver nanowires, copper metal mesh, etc.

The EAP 200, the top conductive electrode 108, and the bottom conductive electrode 202 may be patterned on the touch panel during the manufacturing process of the display device 100. For example, the bottom conductive electrode 202 may be patterned on the touch panel 204, the EAP 200 may be formed on the bottom conductive electrode 202, and the top conductive electrode 108 may be patterned on the EAP 200. Alternatively, the EAP 200, the top conductive electrode 108, and the bottom conductive electrode 202 may be manufactured separately to be later attached to a display assembly to form the display device 100 by, for example, the user.

The bottom conductive electrode 202 substantially covers an entirety of a bottom surface (e.g., a second surface) of the EAP 200, while the top conductive electrode 108 is patterned so as to delineate user inputs (e.g., to delineate a keyboard).

In other embodiments of the present invention, the touch panel 204 and the display panel 206 are not separate layers, but are instead combined at a common layer above the substrate 208. Accordingly, in such embodiments, the bottom conductive electrode 202 is formed on the combined touch panel and display panel layer with the EAP 200 formed on top of the bottom conductive electrode 202. In some embodiments, there is an encapsulation layer between the touch panel 204 and the top conductive electrode 108.

FIG. 2B is a cross-sectional view of the display device shown in FIG. 1 taken along the line II-II when a voltage is applied or when the electroactive polymer is activated.

FIG. 2B illustrates a state in which voltage is supplied to the EAP 200 via the top conductive electrode 108. Referring to FIG. 2B, the voltage source 210 may supply any suitable amount of voltage to adequately compress the EAP 200, such as about 1 kV. For example, at about 1 kV, the EAP 200 may contract from about 4% to up to about 30% at locations where the voltage is applied. Furthermore, there is very little power consumption since there is no flow of current required to maintain the contracted shape of the EAP 200.

When the voltage is applied across the electrodes of the bottom conductive electrode 202 and the top conductive electrode 108, an electric field is applied to the EAP layer 200, causing the EAP 200 to contract in thickness at the portions corresponding to the top conductive electrode 108, while the EAP 200 as a whole expands in area. This expanded area of the EAP 200 aggregates in the locations in between the portions corresponding to the top conductive electrode 108 (e.g., aggregates in the protruding portions 250).

Accordingly, in response to the applied voltage from voltage source 210, the EAP 200 forms a shape that includes one or more the protruding portions 250 at locations where the top conductive electrode 108 is not formed. The protruding portions 250 are surrounded by lowered portions 252 at the portions where the top conductive electrode 108 is formed and where the voltage is applied. It is at the protruding portions 250 where the keys 106 of the keyboard 104 shown in FIG. 1 are formed. Accordingly, the display panel 206 may display characters of the keyboard 104 at corresponding locations of the protruding portions 250.

Additionally, because the EAP 200 expands in area while contracting in thickness at certain locations, the protruding portions 250 increase in thickness to accommodate the material displaced at the lowered portions 252, as discussed above. Thus, high plateaus and low valleys form in response to the applied voltage according to the patterning of the top conductive electrode 108. When the voltage is no longer applied to the EAP 200, the EAP 200 reverts to the original flat shape shown in FIG. 2A due to elastic forces. Accordingly, the display device 100 is capable of relatively responsive switching between the flat shape shown in FIG. 2A and the compressed shape shown in FIG. 2B. For example, embodiments of the present invention may have a switching response time that is less than 10 ms.

Furthermore, either the top conductive electrode 108 or the bottom conductive electrode 202 may be coupled to ground. For example, coupling the top conductive electrode 108 to ground may reduce the possibility of an electric shock felt by the user when the user touches the display device 100.

The voltage source 210 may be at any suitable voltage level, such as about 1 kV. In order to achieve this level of voltage, the display device 100 may utilize the voltage used to power the display device 100 itself. For example, the display device 100 may further include a voltage booster capable of increasing the operating voltage of the display device 100 to a voltage that is suitable to be applied to the EAP 200. By way of example, a battery of the display device 100 may provide voltage at about 3.7V. The about 3.7V may be input into the voltage booster of the display device 100, and may then be increased to about 1 kV before being applied to the conductive electrodes.

The display device 100 may be any touch screen display device, such as a cellular phone, a computer monitor, a tablet, a laptop screen, a portable electronic device, etc. Furthermore, embodiments of the present invention may include any type of touch panel, including a resistive type, an optical type, a capacitive type, etc.

FIG. 2C is a cross-sectional view of a display device according to another embodiment of the present invention.

Referring to FIG. 2C, the display device 260 includes the top conductive electrode 262, electroactive polymer (EAP) 200, bottom conductive electrode 264, touch panel 204, display panel 206, and substrate 208. Additionally, voltage source 210 is coupled to the top conductive electrode 262 and to the bottom conductive electrode 264 through wiring 266. In the present embodiment, the top conductive electrode 262 substantially covers the entire top surface of the EAP 200, and the bottom conductive electrode 264 is patterned.

According to embodiments of the present invention that include a capacitive type touch panel, the bottom conductive electrode of the formable keypad is patterned and the top conductive electrode may be patterned (as shown in FIG. 2C) or may not be patterned. During a touch event at the top conductive electrode, the top conductive electrode moves closer to the capacitive touch panel since the EAP is deformable. During this touch event, a non-patterned bottom conductive electrode may shield the capacitive touch panel, thereby reducing the capability of detecting a touch event by the display device. However, as long as the bottom conductive electrode is patterned (i.e., the bottom conductive electrode is not shielding the capacitive touch panel), touch events may be suitably detected by the display device.

FIG. 2D is a cross-sectional view of a display device according to another embodiment of the present invention.

Referring to FIG. 2D, the display device 270 includes the top conductive electrode 108, electroactive polymer (RAP) 200, bottom conductive electrode 272, touch panel 204, display panel 206, and substrate 208. Additionally, voltage source 210 is coupled to the top conductive electrode 108 and to the bottom conductive electrode 272 through wiring 274. In the present embodiment, both the bottom conductive electrode 272 and the top conductive electrode 108 are patterned to delineate user inputs.

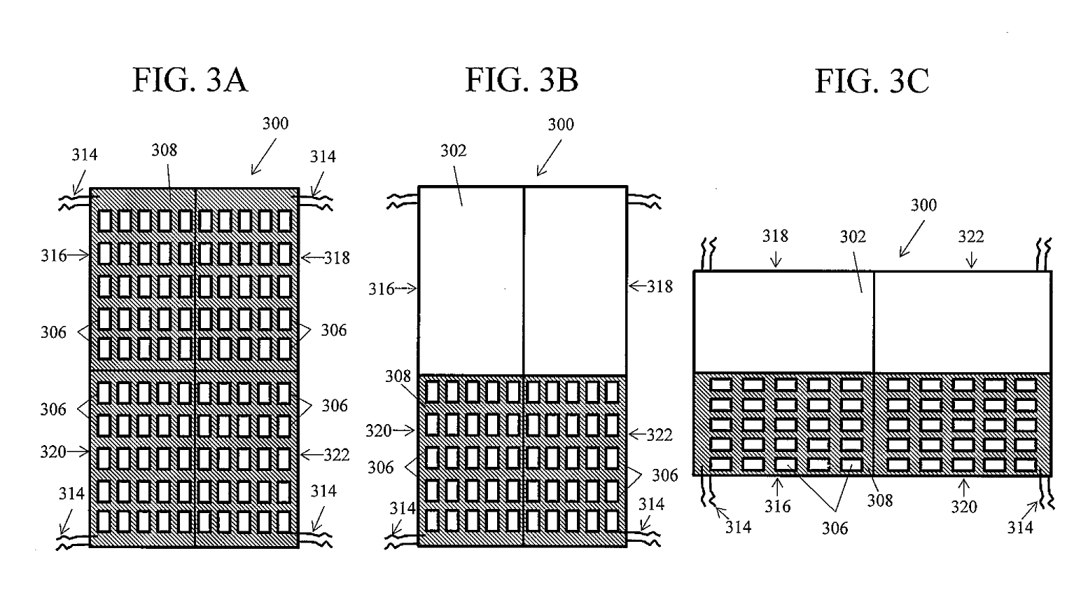

FIG. 3A is a top view illustration of a display device according to another embodiment of the present invention.

Referring to FIG. 3A, the display device 300 includes a top conductive layer 308 covering most of the surface of the display device 300. The top conductive layer 308 of the display device 300 is divided into four zones: a first zone 316, a second zone 318, a third zone 320, and a fourth zone 322. The first through fourth zones 316, 318, 320, and 322 are electrically separated and distinct from each other. The top conductive layer 308 delineates input keys 306 that a user may interact with to input commands to the display device 300.

The top conductive layers 308 at each of the first through fourth zones 316, 318, 320, and 322 may independently receive electric fields via separate wiring 314 coupled to the top conductive layer 308 and to a bottom conductive layer. The bottom conductive layer at each zone 316, 318, 320, and 322 may also be electrically separated or divided and may independently receive electric fields via separate wiring 314. The wiring 314 may also be coupled to a voltage source, for example, to a voltage source that powers the display device 300.

FIG. 3B is a top view illustration of the display device shown in FIG. 3A when used in a portrait orientation.

Referring to FIG. 3B, the display device 300 may be operated in a portrait orientation. In response to a user interacting with the display device 300 in the portrait orientation, the top conductive layer 308 at zones 320 and 322 (i.e., the zones located at the bottom half of the display device 300 that is in the portrait orientation) receives an electric field through separate wiring 314. However, the top conductive layer 308 at zones 316 and 318 (i.e., the zones located at the top half of the display device 300 that is in the portrait orientation) does not receive the electric field.

Accordingly, zones 320 and 322 of the display device 300 have a tactile sensation of the physical keys 306 to the user, while zones 316 and 318 have a flat and smooth surface. Additionally, the keys 306 located at zones 320 and 322 may display characters or inputs associated with each key 306, while zones 316 and 318 correspond to the display area 302. The display area 302 may display anything, such as the characters corresponding to the keys 306 that a user interacts with. For example, the display area 302 may display words that the user types into a keyboard located at zones 320 and/or 322.

FIG. 3C is a top view illustration of the display device shown in FIG. 3A when used in a landscape orientation.

Referring to FIG. 3C, the display device 300 may be operated in a landscape orientation. In response to a user interacting with the display device 300 that is in the landscape orientation, the top conductive layer 308 at zones 316 and 320 (i.e., the zones located at the bottom half of the display device 300 that is in the landscape orientation) receives an electric field through separate wiring 314. However, the top conductive layer 308 at zones 318 and 322 (i.e., the zones located at the top half of the display device 300 that is in the portrait orientation) does not receive the electric field.

Accordingly, zones 320 and 322 of the display device 300 have a tactile sensation of the physical keys 306 to the user, while zones 316 and 318 have a flat and smooth surface. Additionally, the keys 306 located at zones 316 and 320 may display characters or inputs associated with each key 306, while zones 318 and 322 correspond to a display area 302. The display area 302 may display anything, such as the characters corresponding to the keys 306 that a user interacts with. For example, the display area 302 may display in zones 318 and/or 322 words that the user types into a keyboard located at zones 316 and/or 320.

The display device 300 of the present embodiment may include and utilize an accelerometer to detect whether the display device 300 is in a portrait orientation or is in a landscape orientation. In other embodiments of the present invention, the display device 300 may include any other suitable mechanism or method for detecting the orientation of the display device that is known in the art, such as a button or a switch that a user interacts with to indicate the orientation of the display device.

Although FIGS. 3A, 3B, and 3C illustrate an embodiment of the present invention that includes four zones, the number of zones on a display device according to embodiments of the present invention is not so limited. Embodiments of the present invention may include any suitable number of electrically independent zones for facilitating use of input keys on a display device.

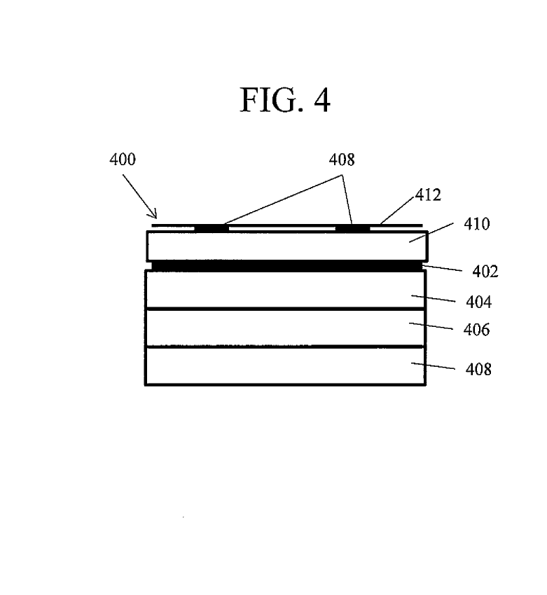

FIG. 4 is a cross-sectional illustration of a display device according to another embodiment of the present invention.

Referring to FIG. 4, the display device 400 is similar to the display device 100 shown in FIGS. 2A and 2B with the addition of protective coating 412.

Display device 400 includes top conductive electrode 408, electroactive polymer (EAP) 410, bottom conductive electrode 402, touch panel 404, display panel 406, and substrate 408. A voltage source may be coupled to the top conductive electrode 408 and to the bottom conductive electrode 402 through wiring. The display device 400 also includes the protective coating 412 on the top conductive electrode 408.

The protective coating 412 may be adapted to reduce or prevent physical damage to the keypad and to easily allow maintenance and cleanliness of the outer surface of the display device 400. The protective coating 412 may be relatively thin in comparison to the other components of the display device 400, such that the protective coating 412 does not restrict movement and flexibility of the display device 400. The protective coating 412 may be flexible and resistant to common solvents.

During the manufacturing process of the display device 400, a coating may be sprayed on the top conductive electrode 408. The coating may then be cured to harden into the protective coating 412. In other embodiments of the present invention, a solid protective coating 412 is formed on the top conductive electrode 408.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A formable input keypad comprising:
an electroactive polymer (EAP) layer having a first surface and a second surface opposite the first surface;
a first conductive electrode pattern defining outlines of user input keys at the first surface of the EAP layer; and
a second conductive electrode pattern at the second surface of the EAP layer.

2. The formable input keypad of claim 1, wherein the EAP layer is adapted to contract at locations of the first conductive electrode pattern when a voltage is applied thereto such that the user input keys protrude.

3. The formable input keypad of claim 2, wherein the second conductive electrode pattern at the second surface of the EAP layer faces toward a display panel of a display device and substantially covers the second surface of the EAP layer.

4. The formable input keypad of claim 3, wherein the first conductive electrode pattern is coupled to ground.

5. The formable keypad of claim 3, further comprising a protective coating covering the first conductive electrode pattern.

6. The formable input keypad of claim 2, wherein the second electrode pattern is patterned to correspond to the outlines of the user input keys.

7. The formable input keypad of claim 2, wherein the first electrode pattern is patterned on substantially an entirety of the first surface of the EAP layer.

8. The formable input keypad of claim 7, wherein the first electrode pattern is divided into zones, each zone being configured to independently receive the voltage.

9. The formable keypad of claim 8, wherein one or more of the respective ones of the zones receive the voltage according to an orientation of the formable keypad.

10. The formable keypad of claim 2, wherein the voltage is about 1 kV.

11. A display device comprising:
a substrate;
a display panel on the substrate;
a formable input keypad on the display panel, the formable input keypad comprising:
an electroactive polymer (EAP) layer having a first surface and a second surface opposite the first surface;
a first conductive electrode pattern defining outlines of user input keys at the first surface of the EAP layer; and
a second conductive electrode pattern at the second surface of the EAP layer.

12. The formable input keypad of claim 11, wherein the EAP layer is adapted to contract at locations of the first conductive electrode pattern receiving a voltage such that the user input keys protrude.

13. The formable input keypad of claim 12, wherein the second conductive electrode pattern faces toward the display panel and substantially covers the second surface of the EAP layer.

14. The formable input keypad of claim 13, wherein the first conductive electrode pattern is coupled to ground.

15. The formable keypad of claim 13, further comprising a protective coating covering the first conductive electrode pattern.

16. The formable input keypad of claim 12, wherein the second electrode pattern is patterned to form the outlines of the user input keys.

17. The formable input keypad of claim 12, wherein the first electrode pattern is patterned on substantially an entirety of the first surface.

18. The formable input keypad of claim 17, wherein the first electrode pattern is divided into zones, each zone being configured to independently receive the voltage.

19. The formable keypad of claim 18, wherein the zones are configured to receive the voltage based on an orientation of the formable keypad.

20. The formable keypad of claim 12, wherein the voltage is about 1 kV.
